(19) United States
(12) Patent Application Publication
(10) Pub. No.: US 2016/0086507 A1
(43) Pub. Date: Mar. 24, 2016

(54) Interactive training device for bowed string instruments

(71) Applicant: Elise Winters-Huete, Austin, TX (US)

(72) Inventor: Elise Winters-Huete, Austin, TX (US)

(21) Appl. No.: 14/489,611

(22) Filed: Sep. 18, 2014

(51) Int. Cl. G09B 15/06

(52) U.S. Cl. CPC G09B 15/06

(57) ABSTRACT

Using a violin teaching apparatus as an example, a training device is disclosed to aid in teaching how to play bowed string instruments. By guiding the motion of a bow teaching apparatus in a manner consistent with the operation of an actual bow, students will learn proper bowing technique. Depending on the immediate pedagogical objective, the motion of a bow teaching apparatus can be limited in terms of back and forth motion as well as the angle relative to the training device. This disclosure can be applied to other bowed string instruments including, but not limited to, a cello and double bass.

### STATEMENT REGARDING PRIOR DISCLOSURES BY THE INVENTOR OR A JOINT INVENTOR

An embodiment of the disclosed apparatus was demonstrated at the American String Teachers' Association National Conference on Mar. 8, 2014 in a presentation titled “A Spoonful of Sugar: Games and Activities that Make Practice Fun.”

### BACKGROUND OF THE INVENTION

A bowed string instrument is a type of musical instrument comprising one or more strings that can be vibrated using a bow to produce sound. Examples of bowed string instruments include a violin, viola, a cello, and a double bass. By moving the bow across the strings, the sound of different notes can be generated to produce music. In learning to play a bowed string instrument, one of the skills that must be mastered is how to maintain the bow at the proper distance and angle relative to the strings.

A bowed string instrument generally comprises two portions. The first portion called the body generally has an ellipsoid shape which is attached on one end to an elongated portion called the neck. Along the outer surface of the instrument are a plurality of strings that are attached from substantially one end of the neck to the other end of the body. The strings are spaced away from the surface of the instrument using a spacer called a bridge. The strings may be arranged in a manner such that the strings form an arc near the bridge and are substantially within the same plane near the neck. The above description of a bowed-string instrument can be modified in numerous ways and still maintain this same general character.

A bow suitable for use with a bowed-string instrument generally comprises a stick and a ribbon, also referred to as bow hair. The ribbon is generally comprised of one or more lengths of a flexible material that is stretched substantially from one end of the stick to the other end of the stick. A bow may also comprise a “frog” configured to receive one end of the ribbon as well as a mechanism for adjusting the tension of the ribbon.

### FIELD OF THE INVENTION

This invention relates to tools used in the teaching of musical instruments. In particular, this disclosure relates to tools used to teach musicians in the art of playing bowed-string instruments.

### DESCRIPTION OF RELATED ART

The primary tool used in teaching musicians how to play a musical instrument is the musical instrument itself. The variability and flexibility that allows trained musicians to produce masterful pieces of art can also distract novice students from learning the fundamental skills necessary to master a musical instrument. In the case of bowed string instruments, one of these fundamental skills is how to maintain the proper form when stroking the bow along the strings. In addition to the vigilant eye of the music instructor, tools may be useful to assist students of bowed string instruments in mastering the proper form.

### BRIEF SUMMARY OF THE INVENTION

The disclosed training device aids in the instruction of playing bowed string instruments, like a violin, for example. By guiding the motion of a bow teaching apparatus in a manner consistent with the operation of an actual bow, students will learn proper bowing technique. Various objects, features, aspects, and advantages of the disclosed training device will become more apparent from the following detailed description of preferred embodiments, along with the accompanying drawings in which like numerals represent like components.

### BRIEF DESCRIPTION OF THE DRAWINGS

FIG. 1A illustrates a view of one embodiment of a violin training apparatus.

FIG. 1B illustrates another view of one embodiment of a violin training apparatus.

FIG. 2A illustrates a view of an embodiment of a bow guide suitable for use with the disclosed violin training apparatus.

FIG. 2B illustrates another view of an embodiment of a bow guide suitable for use with the disclosed violin training apparatus.

FIG. 3 illustrates a bow training apparatus that is suitable for use with the disclosed violin training apparatus.

FIG. 4 illustrates a cross section of a guide body with the neck portion of a violin training apparatus disposed within.

### DETAILED DESCRIPTION

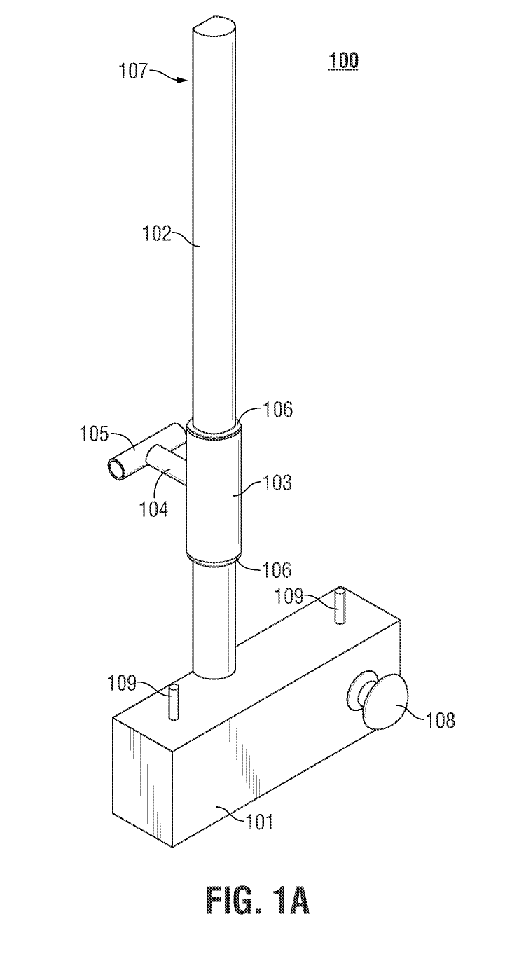

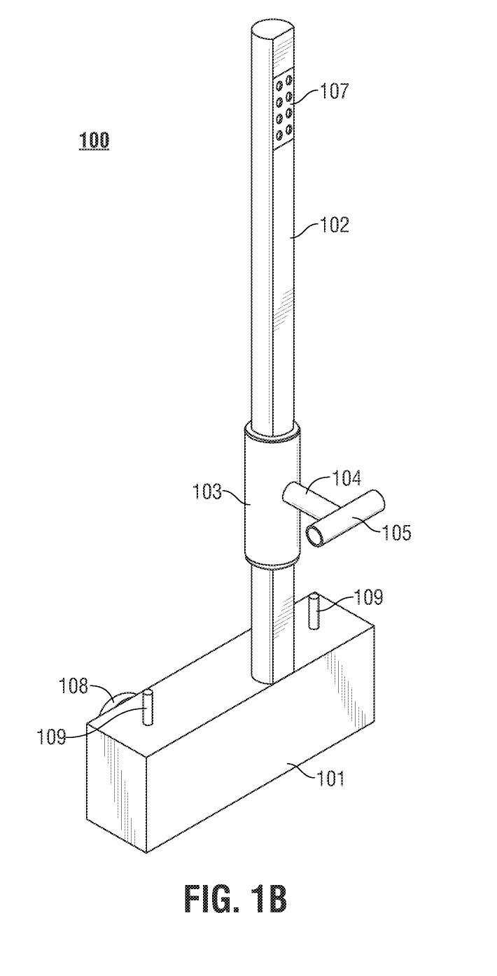

The exemplar violin teaching apparatus 100 shown in FIGS. 1A and 1B (FIG. 1 collectively) comprises a body portion 101, a neck portion 102, a guide body 103, a bridge portion 104, a bow interface 105, two slide stoppers 106, a finger placement guide 107, a positioner 108, and two attachment posts 109. A violin teaching apparatus 100 can be constructed from wood, plastic, metal, composites or other suitable materials using standard manufacturing techniques. The various components can be constructed from different materials.

As shown in FIG. 1, body portion 101 is shaped as a rectangular prism, and can be used to simulate the proximal end (the end nearest to a student) of an actual violin's body. Although illustrated as a rectangular prism, body portion 101 can be adapted to more closely emulate the shape of a violin. The shape of body portion 101 may also be selected for aesthetic purposes, for teaching purposes, or to provide additional comfort for a student.

The neck portion 102 is attached to body portion 101 in a substantially perpendicular manner. However, depending on the shape of body 101 and/or possible aesthetic considerations the connection between body 101 and neck 102 may join at a different angle or location. The neck portion 102 in FIGS. 1A and 1B has a cylindrical shape albeit a cylinder without a circular cross-section. Neck portion 102 has one flat surface defined by a chord as illustrated in FIG. 4. Although illustrated as a substantially straight cylinder of uniform cross-section, the neck portion 102 may assume a variety of different shapes. For example the region between body portion 101 and guide body 103 might have a thicker or thinner diameter than other portions of neck portion 102. Depending on the respective shapes of body portion 101 and guide body 103, there may not be any space between body portion 101 and guide body 103. In another embodiment, the portion between guide body 103 and finger placement guide 107 might have a curved shape for aesthetic reasons. In another embodiment, neck portion 102 may include a loop that could be used to store the violin teaching apparatus 100 by hanging it on a wall, for example. The length of the neck portion 102 can be configured so that the distance between its distal end (end furthest away from body 101) and the proximal end of violin teaching apparatus 100 is approximately the length of a specific type of instrument, such as a violin or cello, for example. The size of body portion 101 can also be configured to control the length of violin teaching apparatus 100.

The guide body 103 is coupled to neck portion 102. Bridge portion 104 is attached to guide body 103 and bow interface 105. For purposes of convenience, the combination of parts and functionality represented by guide body 103, bridge portion 104 and bow interface 105 will be referred to as bow guide 200 when discussing the combination as a whole.

In the embodiment shown in FIG. 1, guide body 103 has a cylindrical opening that is large enough to fit around neck portion 102. Bow guide 200 can be coupled to neck portion 102 by fitting guide body 103 over the distal end of neck portion 102. In another embodiment, neck portion 102 may comprise two pieces that couple directly to either side of guide body 103. This may be accomplished using threads or a barrel joint, for example. In another embodiment, at least one portion of guide body 103 is removable or separable and can be reattached around a section of neck portion 102. For example, guide body 103 might split into two halves connected via a hinge along one side and one or more fasteners on the other side. Guide body 103 could be placed around neck portion 102, and then fastened closed. In this embodiment, the inner surface of guide body 103 might contain a compressible layer (e.g., foam) that will exert sufficient pressure to limit the motion of guide body 103 relative to neck portion 102. This might be desirable for embodiments comprising a neck portion 102 without a uniform cross-section.

The embodiment shown in FIG. 1 includes slide stoppers 106, which prevent guide body 103 from sliding along the length of neck portion 102. A slide stopper 106 could comprise a metal ring, a rubber ring, a clamp, or a peg. In other embodiment, the functionality of slide stopper 106 could be built into the shape of neck portion 102. In other embodiments, the coupling between the guide body 103 and the neck portion 102 may inherently prevent lateral motion of bow guide 200 along the length of neck portion 102.

As an alternative to slide stoppers 106, neck portion 102 and guide body 103 can be configured to limit the lateral motion via one or more grooves on the outer surface of neck portion 102. In this embodiment, guide body 103 may comprise one or more spring plungers configured to couple with one or more of the grooves in the neck portion 102. When engaged, the spring plungers would limit the motion of the guide body 103 in the manner defined by the grooves in neck portion 102. In another embodiment, guide body 103 comprises one or more grooves and neck portion 102 comprises one or more spring plungers. In another embodiment, one or more grooves could be selected from amongst a group in order to place the bow guide 200 at one of several locations along neck portion 102 with each location being substantially prevented from relative lateral motion. This might be desirable to adjust the position of bow guide 200 to accommodate different students and/or to emulate one of several different types of bowed string instruments. In addition to or in lieu of spring plungers, various types of ridges or bearings could also be used to couple the guide body 103 to neck portion 102 in a manner that limits their relative lateral motion.

Guide body 103 and neck portion 102 might also be configured such that bow guide 200 is free to rotate within a limited arc around the outer surface of neck portion 102. This type of configuration can be accomplished a number of different ways. One example is shown in FIG. 4. Using one or more tabs within the inner surface of guide body 103, the rotation of the bow guide 200 relative to the neck portion is limited by the spacing of the tabs. This functionality can also be performed using grooves and spring plungers. As would be understood by a person of ordinary skill in the art, the length of the grooves can be used to limit the arc of rotation of bow guide 200. These same groves can also be used to limit the lateral motion of the bow guide 200 along the length of the neck portion 102. In another embodiment, guide body 103 is not a closed cylinder and neck portion 102 contains one or more tabs that fit through an open portion of guide body 103. The shape and dimensions of the open portion of guide body 103 and any tabs in neck portion 102 could be used to limit the rotation of guide body 103.

Bow guide 200 may also contain a bridge portion 104, which could be a separate structure or an integral part of either guide body 103 or bow interface 105. Bridge portion 104 represents the space between the surface of guide body 103 and bow interface 105. Bridge portion 104 may not be distinct from other portions and could be integral with guide body 103 and/or bow interface 105. The various parts bow guide 200 could also be integrated into a single unitary body.

Violin training apparatus 100 may also comprise a finger placement guide 107 near the distal end of neck portion 102. Finger placement guide 107 can be used to visually mark the fingertip locations utilized in playing a violin. Finger placement guide 107 may be an integral part of neck portion 102 or could be attached to neck portion 102 using adhesive or merely slipped on to the end of neck portion 102 as a sleeve.

Violin training apparatus 100 may comprise a positioner 108 attached underneath body portion 101. Positioner 108 can be used to assist a violin student in properly positioning violin training apparatus 100. The positioner 108 illustrated in FIGS. 1 might come into contact with a student's shoulder so as to encourage proper positioning of violin training apparatus 100. In one embodiment, positioner 108 is removable from body portion 101. A removable coupling between positioner 108 and body portion 101 may be accomplished via the use of a dowel or a screw post, for example. In one embodiment, positioner 108 is shaped like a cabinet knob. In another embodiment, positioner 108 is shaped like the shoulder rest, which is a routine accessory for the violin and various models of which are supplied in all violin shops.

Violin training apparatus 100 may also contain one or more attachment posts 109. Attachment posts 109 can be used to temporarily attach various structures to body portion 101. In one embodiment, attachment posts 109 are configured to receive a chin pad. In one embodiment, the chin pad is attached via elastic straps that loop over the attachment posts 109. Attachment posts 109 may also contain a lip to aid in making attachments to body portion 101. In one embodiment, attachment posts 109 have animal shapes on the ends that are configured to provide a lip for attachments. The position and number of attachment posts 109 illustrated in FIG. 1 merely serve as an example, and can be configured in other ways as desired. In another embodiment positioner 108 is attached to body 101 using one or more attachment posts 109.

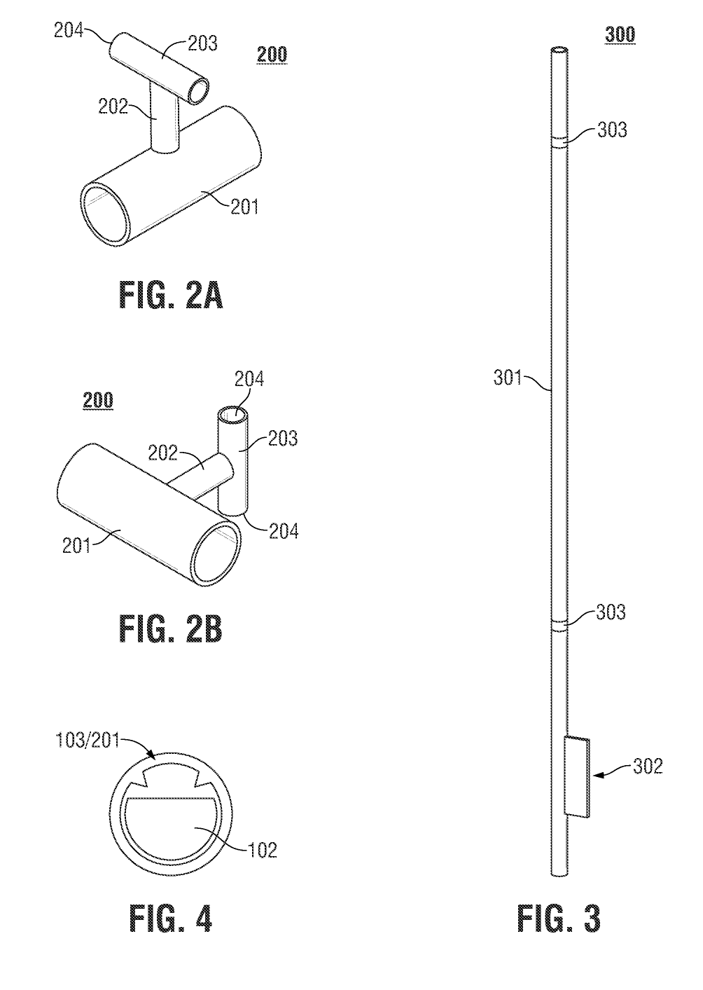

FIGS. 2A and 2B (FIG. 2 collectively) illustrates the bow guide 200 in greater detail. Bow guide 200 includes a guide body 201, a bridge portion 202, and bow interface 203. The bow interface 203 includes two openings 204 that are configured to receive a bow training apparatus 300, such as the one illustrated in FIG. 3. The openings 204 are configured to guide the movement of a bow training apparatus 300 disposed within. As will be discussed further, the shape of the bow training apparatus 300 will inform the shape of the bow interface 203 and openings 204. For example, if the bow training apparatus 300 is shaped like a cylindrical dowel, then the bow interface portion 203 may contain one or more circular openings 204 opposite each other in the manner shown in FIGS. 2A and 2B. Bow interface 203 could form a closed cylinder as shown in FIG. 2. In another embodiment, bow interface 203 is an open cylinder with openings 204 defined by rings. In another embodiment, bow interface 203 may have additional rings between the two outer openings 204. In another embodiment, openings 204 are only partially closed.

FIG. 3 illustrates a bow training apparatus 300 suitable for use with violin training apparatus 100. Bow training apparatus 300 comprises stick 301, frog 302, and one or more stoppers 303. Stick 301 is configured for disposition within bow interface 203. Frog 302 is optional and can be used to simulate the portion of a bow against which the thumb is placed, which in ordinary violin playing houses the tensioning screw and the apparatus for attaching the ribbon. If desired, one or more stoppers 303 can be used to prevent the stick 301 from being inadvertently removed from the bow interface 203 during training exercises.

When disposed within bow guide 200, the motion of stick 301 is constrained by the configuration of bow interface 203. In one embodiment, stick 301 is configured as a dowel with circular cross-section. The motion of stick 301 will follow the path defined by the openings 204. In this embodiment, stick 301 is able to rotate freely within bow guide interface 203. In another embodiment, stick 301 and openings 204 are configured to permit rotation of stick 301 within a certain range. The techniques described above to control the rotation of the guide body 103 with respect to the neck portion 102 can be used to control the rotation of stick 301 within bow guide interface 203.

In one embodiment, bow training apparatus 300 is configured to be inserted into one opening 204 of bow interface 203 and out the other opening 204. In another embodiment, openings 204 are configured such that bow training apparatus 300 can snap into place within bow interface 203. In this embodiment, openings 204 are only partially closed and at least a portion of bow interface 203 is comprised of a sufficiently flexible material that bow training apparatus 300 can snap in and out of place within bow interface 203. In another embodiment bow interface 203 is configured to open and close along its length to permit the disposition of stick 301. For example, bow interface 203 might comprise a hinge that would allow its top portion to swing open to allow stick 301 to be placed within it. Once stick 301 has been put in place, the top portion of bow interface 203 can be returned to its closed position. The structures used to couple bow training apparatus 300 to bow interface 203 can also be used to couple guide body 103 to neck portion 102 and vice versa.

In another embedment, bow interface 203 is removable from bridge portion 202. Bow interface 203 comprises a post that can be inserted into an opening within bridge portion 202. This allows the same violin training apparatus 100 to be utilized with different bow interfaces 203 having different properties. For example, different sizes of bow interfaces 203 could be designed to accommodate different sizes and configurations of bow training apparatus 300. The bow interface 203 can also be integrated with the bow training apparatus 300 in a manner that is not easily separable. Thus, the integrated bow interface 203 can be inserted into the bridge portion 202 to complete a violin training apparatus 100 with bow training apparatus 300 disposed within.

Although the previous discussion was in the context of a violin teaching apparatus, the teaching of this disclosure can easily be adapted by a person of ordinary skill in the art to other musical instruments. For example, the violin teaching apparatus 100 could be adapted to teach other bowed string instruments, such as a cello or double bass. One way the adapt a violin teaching apparatus 100 for use as a cello teaching apparatus might be to extend the next portion to the length of a typical cello and adapt the body portion for contact with the ground by adding an end pin. In another embodiment, the body portion may be adapted to rest on a student's lap as opposed to extending all the way to the ground as would an actual cello. To the extent that teaching is focused on the bowing aspect of a bowed string instrument, other features of a bowed string instrument might be needed for pedagogical purposes.

Although the present invention and its advantages have been described in detail, it should be understood that various changes, substitutions and alterations can be made to the embodiments described herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A teaching apparatus for a bow string instrument comprising:
a body;
a neck coupled to said body;
a bow guide coupled to said neck at a substantially fixed distance from the distal end of the neck, the bow guide comprising a bow interface that is configured to receive a bow teaching apparatus; and
wherein the motion of a bow teaching apparatus disposed within the bow interface is substantially restricted to a linear path defined by the bow interface.

2. The teaching apparatus of claim 1, further comprising a shoulder positioner coupled to the body.

3. The teaching apparatus of claim 1, further comprising a finger placement guide coupled to the distal end of the neck.

4. The teaching apparatus of claim 4, wherein the bow guide is coupled to the neck in a manner that allows the bow guide to rotate around the neck within a limited arc.

5. The teaching apparatus of claim 1, wherein the linear motion of a bow teaching apparatus disposed within the bow interface is restricted to a substantially fixed length of the bow teaching apparatus.

6. The teaching apparatus of claim 1, wherein the bow guide is coupled to the neck in a manner that allows the substantially fixed position of the bow guide relative to the distal end of the neck to be adjusted to a new substantially fixed position.

7. The teaching apparatus of claim 1, wherein the bow interface is configured to partially inhibit the rotation of a bow teaching apparatus disposed within.

8. The teaching apparatus of claim 1, wherein the distance between the distal end of the neck and the opposing edge of the body are approximately the length of a violin.

9. The teaching apparatus of claim 8, further comprising a chin rest coupled to the body.

10. The teaching apparatus of claim 1, wherein the distance between the distal end of the neck and the opposing edge of the body are approximately the length of a cello.

11. The teaching apparatus of claim 10, further comprising an end pin.

12. The teaching apparatus of claim 1, further comprising one or more attachment posts coupled to the body.

13. A teaching apparatus for a bow string instrument comprising:
a body;
a cylindrical neck coupled to said body; the length of the neck combined with the width of the body are approximately the length of a violin;
a bow guide coupled to said neck at a substantially fixed distance from the distal end of the neck;
a bow interface coupled to said bow guide in a substantially fixed position relative to the bow guide, the bow interface being configured to receive a bow teaching apparatus;
wherein the motion of a bow teaching apparatus disposed within the bow interface is substantially restricted to a linear path defined by the bow interface, the linear path being substantially perpendicular to the neck;
a shoulder positioner; and
a finger placement guide.

14. The teaching apparatus of claim 14, wherein the bow guide is coupled to the neck in a manner that allows the bow interface to rotate around the neck within a limited arc.

15. The teaching apparatus of claim 14, wherein the cylindrical neck has a circular cross-section.

16. The teaching apparatus of claim 14, wherein the bow guide is maintained at the substantially fixed distance from the distal end of the neck by one or more slide stoppers.

17. The teaching apparatus of claim 14, wherein the bow interface limits the rotation of a bow teaching apparatus disposed therein to within a fixed range.

18. A teaching apparatus for a bow string instrument comprising:
a body;
a neck coupled to said body;
a bow guide coupled to said neck; and
wherein the bow guide comprises a bow interface means for restricting the motion of a bow teaching apparatus disposed within the bow interface means to a linear path.

19. The teaching apparatus of claim 18, wherein the bow guide is coupled to the neck using a bow coupling means that allows the bow guide to rotate around the neck within a fixed arc.

20. The teaching apparatus of claim 18, wherein the bow guide is integrated into.
